(19) United States
(12) Patent Application Publication
(10) Pub. No.: US 2011/0282752 A1
(43) Pub. Date: Nov. 17, 2011

(54) Website Creation Method

(76) Inventors: Gregory J. Manriquez, Pflugerville, TX (US); Stevan H. Lieberman, Silver Spring, MD (US)

(21) Appl. No.: 13/107,630

(22) Filed: May 13, 2011

Related U.S. Application Data
(60) Provisional application No. 61/334,535, filed on May 13, 2010.

(51) Int. Cl. G06Q 30/00; G06Q 10/00

(52) U.S. Cl. 705/14.73

(57) ABSTRACT

Creation of a website that gathers data on visitors as if it is run by an actual company related to the content of the website. The data gathered on visitors is then sold and/or the entire website is then sold. The website is not a shell or template, but rather is an actual operating website that generates its own traffic and advertisements. The website can even feature polls, contributions, and email lists.

### CONTINUITY DATA

This is a non-provisional application of provisional patent application No. 61-334,535 filed on May 13, 2010 and priority is claimed thereto.

### FIELD OF THE PRESENT INVENTION

The present invention is a method for creating a website, and more specifically, the present invention is a method for creating a website focused on a political issue. The website is fully developed and built out per a political issue and then data is sold and/or rented or the website is sold and/or rented as a package.

### BACKGROUND OF THE PRESENT INVENTION

Websites have become more than just a dalliance in creativity. While the 1990's saw an explosion in Internet use, with terms like “surfing the net” commonly and fashionably used, the Internet has now evolved to the point where serious money can be made via webpages. A successful website can generate money 24 hours a day while its owner does not even monitor it. Some websites have become so successful that they provide owners' sole income. Moreover, some websites, or even merely the domains of websites are actually bought and sold for millions of dollars because they represent a valuable property interest that can generate income.

One way to make money on the Internet is to have a lot of traffic (visitors) come to a website. Much like a shopping mall that looks the fanciest to generate many shoppers walking its concourses, websites look to attract as much traffic as possible by offering targeted information to a perceived audience. For example, a website might feature information on local gas stations offering the lowest gasoline prices. The target audience would be local individuals concerned about paying high prices for gasoline. When a large number of such individuals visit the website, then the website can show the traffic and interest advertisers. Local gasoline stations desiring to advertise to such individuals are willing to pay for advertising on the website because they know that advertisements will reach such individuals.

Some websites literally feature a particular business, and those websites attempt to generate customers or clients for the business; thus, the websites are essentially an advertisement. For example, the website www.APLegal.com is a website that is primarily concerned with providing information to prospective and current clients. Some websites, like www.APLegaL.com, also act as file access portals for current clients, so the websites do more than just act as an advertisement.

Other websites actually provide information about certain topics, and then generate money by referring people to other websites. Monetization on the Internet refers to generating money from a website. More particularly, monetization typically occurs when advertisements are clicked on a website. The website typically receives money for each advertisement that is clicked on the website.

There is one commonality between all websites though: there is always an actual individual or company for whom the website is created. For example, www.APLegal.com was created for a particular law firm, www.Google.com was created for a search engine company, www.TheProdigy.com was created for a music group. Most website designers will even go so far as to say that a website cannot be created without knowing who the owner will be. Particular information content, website layout, and complexity should be determined by the owner of the website. For example, one law firm might want a basic website that provides a description of the law firm, contact information, and background information on law firm attorneys. Another law firm might want a website that features the multitude of cases and projects that the law firm has handled. Of course, website owner's budget will drive how much time and effort is expended to develop the website, i.e. a budget of $5,000 will fund a website that most likely will pale in comparison to a website that is funded with a budget of $50,000.

It is important to realize that no matter what purpose or budget is associated with a particular website, the owner of the website must traditionally be known prior to creating the website. All creation of the website flows from the identity of the owner. Whether the owner directs website creation or not, knowing who the owner is allows the website developer to create the proper website.

But what would happen if a website were created without an owner being known? There are templates that are offered for sale for particular lines of businesses. For example, a florist can go online and purchase a generic website that was designed as a generic florist website. The seller can then add in the florist's particular name, contact info, etc. upon sale of the website. In such a case, a website would be created and sold without detailed knowledge regarding the florist; however, the website would be merely a template, and nothing more. A history of traffic wouldn't exist for the website because the website would never have had any traffic—in fact, the website would really have been just a template waiting to go live.

There is a need for a fully built out website that has been live and has an established presence, all the while without an actual buyer having ever owned the website. An established website has known traffic, and that traffic is of value to a potential buyer. A website that has an established presence with good traffic volume can be used to promote the potential buyer's own products or services. Alternatively, a website that has an established presence with good traffic volume can be used to feature advertisements that the potential buyer intends to place on the website. In any case, there is a lot of value in an established website as opposed to a mere template or shell website.

Companies build out fully functional websites currently, however, the websites are merely traffic generation tools without a real identity. For example, a website might exist for information about buying a house, but there is not an actual company to contact that owns the website that is capable of helping you buy a house. The website is merely owned by a company that hopes to promote the website and eventually sell it to a company that does help you buy a house. There is more value in a website that represents an actual company that offers the goods and services on the website, as compared to a website that represents nothing, acting only as a portal website without a company. There is also value in a website that represents an actual company that offers the goods and services on the website—or promotes a cause—because such a website produces valuable data that can be offered for sale.

Currently, the only way to purchase a website—or obtain data from a website—that has a fully established presence is to buy such a website or data from a company that has been using the website to promote its own goods and services—or promoting a cause. Obviously, if a website is not owned by a company that has been promoting its own goods and services or a cause, or at least its own opinion about something, then the website will not have a fully established presence. A fully established presence is more than just a having traffic, but it means a website that is owned by a company that has been promoting its own goods and services, or at least its own opinion about something.

There is a need for a website creation method that allows website creators to offer fully established websites for sale, as well as the data generated by such sites. Website creators are currently cut off from being able to offer a fully established website and related data because there is a need for an actual company that has been promoting its own goods and services, or at least its own opinion about something, to own the website prior to sale of the website or data from the website.

### SUMMARY OF THE PRESENT INVENTION

The present invention pertains to preferably secured server computer with ample memory available, hosting a series of websites to the Internet, each with a unique domain or URL address, bank account funding, created in a semi-automated fashion via the unique method of the present invention. These websites function to collect and disseminate data with the intent of selling the polling and location data and/or websites in packages to interested parties, as well as to generate advertising revenue.

The present invention is a website creation method that focuses on the creation of a live, interactive website for a particular purpose. A company is formed that owns the website, and that company has actual bank accounts. Advertisements are then produced to generate traffic for the website. Once the website has sufficient traffic, the website's data and/or the website itself is then offered for sale along with all traffic data and visitor data. The intent is to sell fully-fledged websites and/or website data to appropriately targeted companies that were designed and maintained for a specific purpose. For example, a website created under the method of the present invention could provide hair fashion tips as well as salon directions and other hair related information to a group of visitors, generating traffic, and polling them on hair care preferences, generating data relevant to hair care corporations. The website as a whole is then marketed as a package, and the end-buyer, preferably a hair dresser or hair-related company, may then purchase the website content, as well as the domain and design, including its propensity to attract visitors. Further, surveys could be conducted on the website while it is still for sale, which can generate additional data, such as a public survey on hair care products. This data is then aggregated and is also sold along with the website, or independently. This data can be helpful for the website buyer; as it can be implemented into product sales, given that the buyer of the website will wish to supply goods that are in higher demand, as portrayed by the survey conducted on the website.

Website content is preferably updated automatically to the websites crafted via the present invention. The creation of the content is not automated; however it is collectively drawn and gathered together in a real-time database, procuring the content to be displayed on the array of websites. This occurs via a process beginning with a very broad search of the internet, government logs, or any other source of digital information readily available which would be pertinent or applicable to the specific purpose the website was designed for. In the preferred embodiment of the present invention, the specific purpose of the websites to be generated is political in nature. Therefore, a real-time database is constructed, external to the websites, yet providing content for the websites, which houses government logs for all new and current political issues under review. The database is consistently reorganized and refreshed, such that it contains the most recent politically applicable data and stories, and is also arranged such that it is easily searchable by location, issue topic (including House or Senate bill number), as well as political category based on keywords. The database performs these functions by searching and scanning the content of political issues for specific keywords, which may help to link stories, as well as to cross-reference websites created via the present invention to maximize visitor impressions.

Visitor impressions are critical for an enterprise such as this, given that full website sales may be seldom, and therefore, the majority of income from the present invention is conferred by advertisements such as Google AdSense, as well as through the sale of data packages containing visitors' IP and polling information. With each impression that an advertisement receives, a possibility exists for the advertisement to be clicked on. Ergo, the more people that view the website, the greater the probability that an individual will click on a paid advertisement link, generating funds for the website.

The home page of each website is populated by polls, live updates from relating topics on social feeds, such as Facebook™ and Twitter™, advertisements, a search query field, as well as links to stories and other aggregate data provided via the database. Additional revenue will be generated by selling the packaged data procured by visitor statistics cross-referenced with an IP database to determine visitors' locations, as well as visitor opinion preferences procured via the website poll.

### BRIEF DESCRIPTION OF THE DRAWINGS

FIG. 1 is a flow chart of the preferred embodiment of the present invention.

FIG. 2 shows how the present invention analyzes and issue that is the subject of a website of the present invention.

FIG. 3 shows an example of the preferred result of the present invention.

### DETAILED DESCRIPTION OF THE PREFERRED EMBODIMENT(S) OF THE PRESENT INVENTION

The preferred embodiment of the present invention relates to a method by which websites are crafted without guidance of the end-buyer, and whose content is categorically organized based on keyword topics preferably procured via a database (10) search of issues and Senate and House of Representatives bills currently under debate or legislation. According to one embodiment of the present invention, a series of websites are to be built that focus on political issues, each independently tailored to a select issue or set of issues, yet often cross-referenced to other websites. Thus, the first step of the present invention is to build a database (10) of all bills, laws, legislation, bond offerings, etc. in the United States—assuming that the website is to target the United States demographic. The database (10) would preferably focus on any form of government action that requires election or debate by either government representatives or the general public.

Next, an online campaign would be designed for each debatable or political issue that a prospective buyer might be interested in seeing represented on a website. This is enacted without consent or even knowledge of the potential, unidentified buyer. The website would be seeded with information about an actual new company that is controlled by the website creator. Extensive use of the new company per issues in the database (10) is represented on the website. Additionally, bank accounts are created for the new company. This new company functions as both a placeholder for the potential future buyer of the website, or merely the data collected by the website. In effect, the website as a whole is created for the new company, as if the new company is under the management of the website creator, the manager of the method of the present invention. As the intent is to sell the website or website data after construction is completed and poll (240) and other data is gathered, the management of the website by the website creator may therefore be temporary. However, the website need not be sold as a whole to the buyer; rather visitor data generated by the poll (240) may be sold at the request of a buyer. Visitor information may be sold as well, which is collected based on the visitor's IP address.

Therefore, extensive use of external IP (Internet Protocol) address databases is preferably implemented to capture visitors' location data, enabling the localization of advertisements (200) per each debatable issue in the database, custom tailored for each visitor's region. The process involves the following:
a. Legal team reviews company and bank account formation
b. Marketing team builds:
   i. Concept
   ii. Text
   iii. Image
   iv. Online process
      1. Webpage can be created
      2. Facts profile of issue built
c. Operations team
   i. Puts plan into effect
   ii. Any technical hacks needed are built
d. Data Team
   i. Collect data for use
      1. Includes buyer profile
      2. Clicker profile
      3. Action profile of user
      4. Mouse tracking data
   ii. Trends, profiles, issues
   iii. Data is packaged and put up for sale.

The data being packaged and put up for sale is important, because the entire website can be sold at this point, or in the preferred embodiment of the present invention, only the data is packaged and put up for sale, and the website continues to function, generating data. The data is valuable to political activist groups, political candidates, political party members and similar groups in reaching constituents, building a webpage, and understanding where support for pressing issues resides.

For example, a political advertiser might want to promote a concept, such as to raise taxes to pay for a new bridge in town. The political advertiser is willing to pay $100 a day to voice his or her opinion. According to the preferred embodiment of the present invention, an internet domain for the campaign is registered (60), a politics website for that campaign is created and the website is configured preferably with a conventional DNS nameserver to link to the newly created domain. The end result is a politics webpage that is key word driven. Further, every election is translated into a key word advertising campaign. For each bill that passes—whether at the federal, state, or municipal level, key word content is weighed. The text of any bill is preferably placed on a website, and a distinct URL is created for such purpose. The keywords found in each bill are then used to automate the creation of appropriate and applicable advertisements (200) on the Internet. Advertisements (200) are also custom tailored according to the location of the visitor, which is provided by the IP information gathered when the visitor accesses a website when the visitor's IP address is cross referenced against an external IP database, such as WhoIs™ or Name Intelligence™.

The number of people who visit or ‘hit’ the website, as well as location data pertaining to where the people are from, and any other information that can be gathered is preferably dropped into a relational database, thereby creating a profile for both a political bill and a related political issue. This database is separate from the real-time database (10) containing government logs and other website content. Further, social networking sites are then scraped for the associated key words and individuals who have commented on the keywords/issues are notified of the website through the different social networking venues and given an opportunity to comment through their own social networking avenues/feeds. The profile can be employed when creating future advertising campaigns. The profile can also be sold to interested parties.

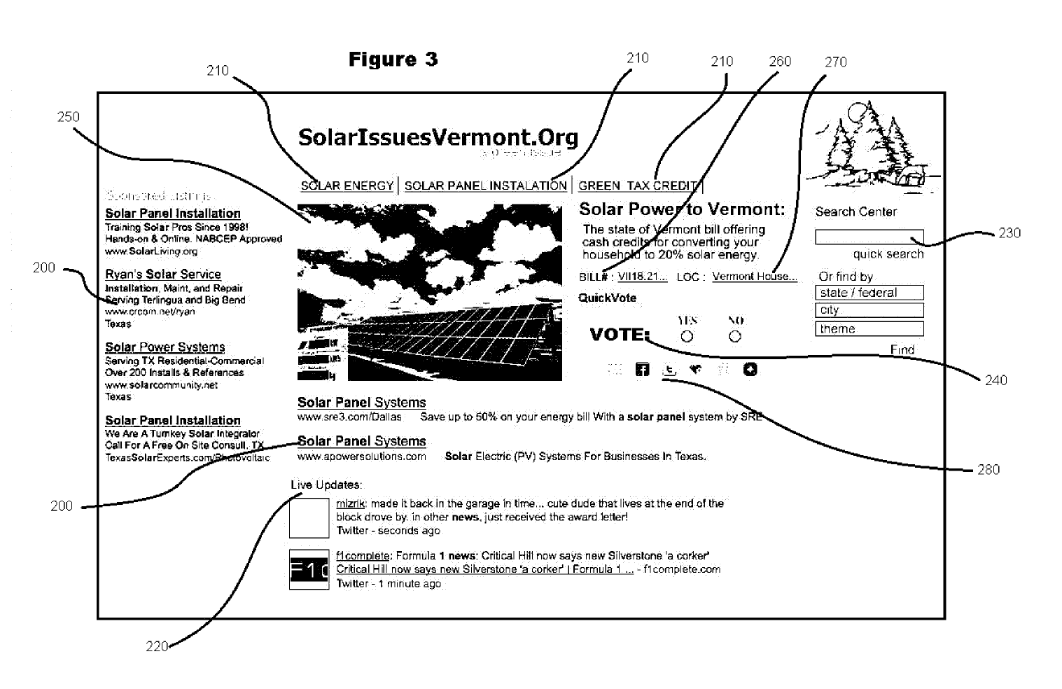

Per the present invention, commentary sections are preferably incorporated into each website. The commentary is preferably only accessible by those who pay to provide commentary on the topic presented by the website. The paid concept serves to weed out undesirable commentaries that oftentimes are not terribly relevant or of low value to the website. Commentaries are to be understood as distinctly different from a conventional comment dialog box found at the bottom of conventional forum websites. Comment dialog boxes may or may not be incorporated into a crafted website. However, in preferably all websites, any method of posting comments via any known social media system is accepted from visitors, as can be seen by the Facebook™ and Twitter feed updates or ‘live updates’ (220) portion of the example homepage seen in FIG. 3. Additionally, poll (240) questions are posted to the websites to collect data, which can later be sold to the buyer. Email update features exist and are preferably prevalent, embodied by ‘email links’ so that visitors to the website can feel part of and interact with the website and other visitors, and a culture of active participants is nurtured. Donations to the cause that the website may focus on, such as a political contribution or charitable donation can also be received through the website.

In one embodiment of the present invention, the focus is placed on the realm of politics and therefore, to create a custom tailored site by the method of the present invention, a political issue is isolated. Based on this issue, a position is taken either for or against the issue, which forms the basis for keywords that are developed based on the positions presenting the most interest and value regarding the issue. Additionally, the website presents visitors with an option to vote for or against the issue at hand in a poll (240)—or in other words, would people prefer more of one thing and less of another. The website queries users about accepting alternatives to the issue, which are posited by the website, and political alternatives are surveyed and collected. By doing such, the present invention allows a vote census to be conducted, and better keywords to be developed from each user's information and input (and the keywords are weighted based on frequency). Consequently, the website can adapt to cater to visitors' continued interest in a topic relating to the issue. Likewise, the website can calculate how likely a change in visitors' sentiment might be based on votes; and potential changes in visitors' sentiment can be listed. Visitors can then Tweet™ directly to their own political creations, so even more traffic could be driven to websites crafted via the method of the present invention. Each visitor can actually view the political messages that other visitors are posting on the website via the social network integration links (280) and live updates (220) portions of the websites. Advertisements (200) are displayed along with the political messages that other visitors are posting in the live updates (220) portion of the website. Money can be paid to preferably promote a concept or position that will show along with messages containing certain keywords.

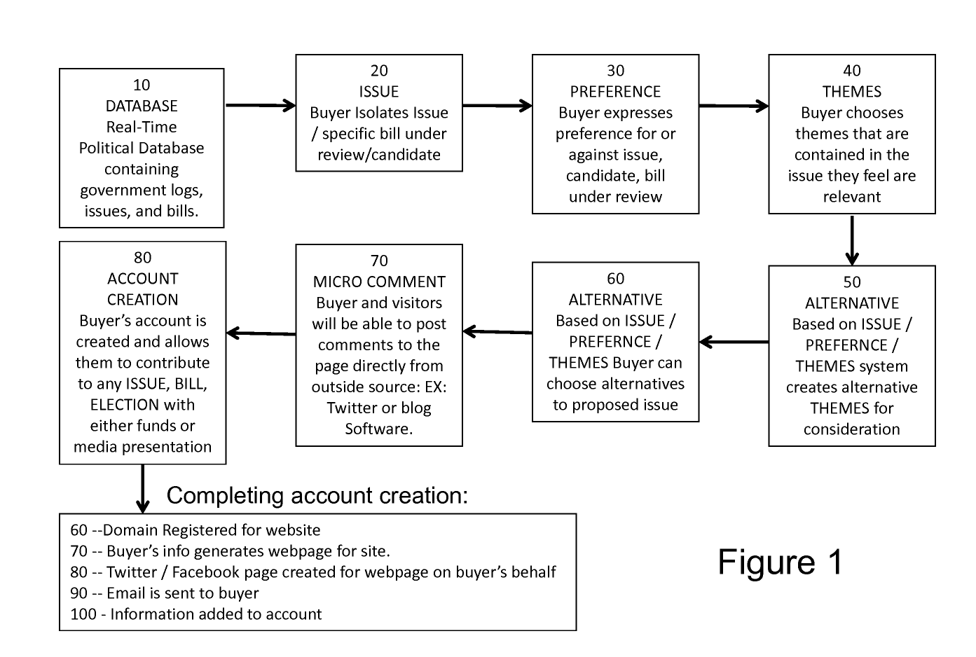

FIG. 1 presents a flow chart of the preferred embodiment of the present invention. In it, one can see the timeline progression of the creation and content population of a website crafted via the method of the present invention. First, an issue, bill, or newsworthy topic is presented by the media or other news outlets and is located in government logs. This topic is then picked up during the sweeping scans of the internet and pertinent government logs (120) which was conducted, and is then added to the database (10) of the present invention. In the preferred embodiment of the present invention, this database (10) is generally restricted to contain political issues and stories; however, it can be envisioned that the database (10) foundation of the present invention could be configured to capitalize on a wide variety of newsworthy stories or opinions used to spark interest, discussion, and ultimately, visits to the websites of the present invention, effectively driving revenue from advertisements (200).

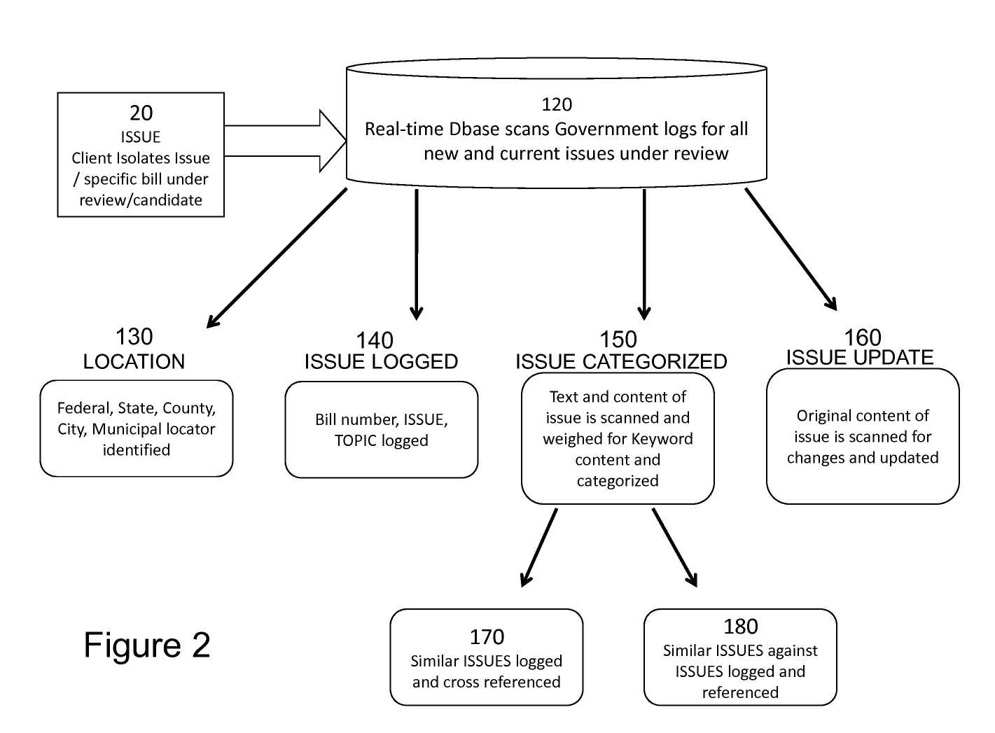

In FIG. 2, the process for database (10) scanning and information gathering is outlined. In the preferred embodiment of the present invention, the basis for each website is determined by any current political stance towards any current or pending bill, issue, or debate. This issue may either be isolated by the client or buyer (20), or it may simply be pre-emptively created based on the bill or issue's existence alone, with the forethought of believing the issue will be prevalent or important enough to draw in visitors to provide opinion polling results and hits to a custom tailored website geared to collect or disseminate information pertaining to a specific topic, bill, or issue. A real-time database (10) performs a routine scan of all government logs for all new and current issues under review (120), especially those pertaining to the United States. The following data is added to the database for use on a website created via the method of the present invention: Location data of the government bill or issue, shown as ‘location’ (130), specified by whether the bill is related to the federal, state, city, or county government, and bill information, including the bill number, issue title, and topic, shown as ‘Issue Logged’ (140). After the location (130) and data of the issue is logged (140), the text itself of bills, issues, and media articles is scanned and evaluated by the database (10) on the computer for specific, prudent keyword content, which is then categorized and organized by keywords, shown as ‘Issue Categorized’ (150). Given that information pertaining to bills and issues of the government are often subject to change, to keep the data current, the database performs update scans of the original content of issues to check for changes, and to keep the issue current in real-time, shown as ‘Issue Update’ (160).

FIG. 3 displays an example of the preferred output of the method of the present invention as presented in a website homepage hosted by a server computer. Within the drawing, the preferable location of advertisements (200) can be seen, which are crucial to generating an income stream from the websites created via the preferred embodiment of the present invention. Similarly, the preferable placement of cross-reference links (210) can be seen. These cross-reference links (210) generally link back to other sites created via the method of the present invention, which helps to drive more visitors to more websites, generating additional data, which can then be sold in a package with the website as a whole, or independently to a buyer.

It should be noted that, according to the present invention, when a website is created, bill content is created relating to other bills of similar topics (170), which are linked in the database (10) by their keywords. Senate and House of Representatives bills, as well as local government bills are also referenced that may relate to an opposing position from the bill of interest, shown as ‘log opposing issues’ (180)—and websites can be created to allow donations regarding those bills as well. Issues similar to the political bill or issue found during the database (10) scan of government logs are logged and cross referenced (170) in the database (10), and the content is ultimately displayed on a website. Opposing issues, or similar issues against an issue logged and referenced (180) in the database (10) may be used for site content as well, which may draw additional visitors. For example, if someone wants to support a bill that aims to save the spotted owl in Florida, and similar bills in Arizona and Florida are drafted as well, then websites can be generated for all three bills, each configured independently and slightly differently. The sites may be linked for cross-referencing purposes, given that they are related to similar material or issues—namely, wildlife protection issues. An example of these cross-reference links (210) can be seen in FIG. 3. Interaction with social networking systems is provided as well via the social network integration links (280), such that an individual's friends may be notified about a website created via the method of the present invention pertaining to a specific issue that has arisen in the realm of politics, or any other field of interest to the visitor, or his or her Facebook™ friends. For example, per the present invention, someone's political issues, preferences, and opinions may then be passed on to Twitter™ and Facebook™, and links to the website may be shared easily to social networks as well, with just one click from the social network integration links (280) as seen in the exemplary example in FIG. 3. If an individual or visitor posts a Facebook™ or Twitter™ micro-comment (70), or if he or she posts any material to his or her Facebook™ wall, the related keyword post will appear on the live updates (220) portion of the webpage. Data gathered from the website poll (240) is stored in the database as well, and is ultimately bundled in the package which is for sale to a buyer. The data can be helpful in crafting political campaigns and targeting constituents. Consequently, data aggregated from these webpages is packaged and sold as user customizable reports. The data will be separated and organized into sections including visitor IP addresses (providing location data when cross-referenced against an IP database), users preferences on issues determined by polls (240), as well as web browsing patterns acquired by browser cookie data.

It should be understood that the present invention could additionally interest companies or buyers who are not necessarily tied to a political issue. For example, a business interested in earning money from debt consolidation could easily purchase data or an entire website that focuses on debt consolidation as a political issue.

Additionally, it can be envisioned that, for a yearly fee, buyers can create their own political issues—based on existing or future issues, using the webpage pre-fabrication tools implemented in the present invention. These tools include a mandatory ‘vote’ on the issue at hand in a poll (240), synopsis of issue and advertisements (200) purchased from the initial fee. Also, in an alternate embodiment of the present invention, it can be envisioned that a buyer may also adopt or rent an existing political issue's website and manage the integrated discussion for a monthly fee.

Alternate embodiments of the present invention could include variations on the content provided to the database (10). The database (10) component of the present invention could be configured to search the internet and other media sources for a wide variety of topical points worthy of discussion among visitors of a website that are not necessarily related to politics at all. For example, topics could pertain to: sport team management issues, computer repair debate or opinions, car maintenance queries and problems, do-it-yourself home maintenance. Each topical order would preferably have an independent database (10) querying the Internet for stories, matters, logs, opinions, and social network feed posts relating to each potential topic of interest.

We claim:

1. A website creation method, comprising:
building a first database that focuses on a first issue on a computer;
the computer scanning for information about the first issue on the Internet and contributing that information to the first database;
the computer seeding a website with the first database;
the computer seeding the website with information about a company controlled by a creator of the website;
the computer displaying advertisements on the website; and
selling the website.
